(19) United States
(12) Patent Application Publication
(10) Pub. No.: US 2026/0118527 A1
(43) Pub. Date: Apr. 30, 2026

(54) Optimized Scintillator Screens for Use in X-ray Imaging

(71) Applicant: Rapiscan Holdings, Inc., Hawthorne, CA (US)

(72) Inventor: Aaron Judy Couture, Reading, MA (US)

(21) Appl. No.: 19/008,953

(22) Filed: Jan. 3, 2025

Related U.S. Application Data
(60) Provisional application No. 63/617,226, filed on Jan. 3, 2024.

(51) Int. Cl. G01T 1/20; C09K 11/77

(52) U.S. Cl. CPC G01T 1/2002; C09K 11/7701; C09K 11/7733; G01T 1/2006

(57) ABSTRACT

A scintillator screen for use in backscatter and transmission X-ray detectors is provided. The scintillator screen includes at least a phosphor layer comprising a plurality of phosphor particles preferably having a mean particle size ranging from 30 μm to 70 μm, and preferably from 30 μm to 50 μm. Alternatively, each of the plurality of phosphor particles has a particle size in a range of 30 μm to 70 μm, and preferably from 30 μm to 50 μm. A thickness of the scintillator layer ranges from 100 μm to 4000 μm while packing fraction of phosphor weight to total weight of phosphor and a binder ranges from 50% to 90%. The phosphor layer preferably includes europium-doped barium fluorochloride (BaFCl:Eu) for use in a backscatter X-ray detector and preferably includes Gadolinium Oxysulfide (Gd₂O₂S) for use in a transmission X-ray detector.

### CROSS-REFERENCE

The present specification relies on U.S. Provisional Patent Application No. 63/617,226, titled “Optimized Scintillator Screens for Use in Backscatter X-Ray Imaging”, filed on Jan. 3, 2024, for priority. The above-mentioned application is herein incorporated by reference in its entirety.

### FIELD

The present specification relates to scintillator screens that are optimized for X-ray imaging. In particular, the present specification relates to scintillator screens having improved light extraction characteristics.

### BACKGROUND

Backscatter technology is based on the Compton scattering effect of X-rays, a form of ionizing radiation, whereby backscatter detection systems detect radiation that reflects from the object and generates an image using the scattered rays. In contrast, transmission X-ray imaging systems rely on the transmission of X-rays through an object in order to generate an image. X-ray detectors typically used in various imaging systems typically comprise a scintillator layer. As is known, X-ray detectors comprise scintillators that are materials that absorb energetic radiation such as gamma rays, X-rays, or neutrons and convert that energy into short bursts of visible photons. These photons are then converted into electrical pulses by photodetectors. The scintillator layer may be deposited directly onto a photodetector with no supporting substrate or may be deposited onto a substrate to form a screen which can be installed into an enclosure.

Usually, phosphor compositions are used as scintillator materials in detectors to absorb X-ray radiation and convert the absorbed energy into visible light photons. The phosphor compositions typically comprise phosphor powder which includes a high concentration of elements with a high atomic number and a luminescent dopant to increase light output of the scintillator screen. For example, materials such as, Barium Fluorochloride (BaFCl) doped with Europium are widely used as scintillator materials in backscatter imaging detectors.

U.S. Pat. No. 4,524,016 discloses a “process for preparing spheroidal particulate BaFCl:Eu phosphor having a narrow size distribution, which process comprises: (a) spray drying the slurry comprised of BaFCl, or the precursors thereof, a europium halide, and a BaCl.sub.2 flux in a liquid under conditions which produce porous spheroidal agglomerates of BaFCl, or the precursors thereof, BaCl₂, and the europium halide, the agglomerates having an average diameter larger than the desired diameter of the particulate phosphor; (b) firing the porous spheroidal agglomerates of step (a) in a flowing inert atmosphere for about 10 to about 120 minutes at a temperature of about 650 degrees C. to about 950 degrees C.; (c) cooling the fired material of step (b) to ambient temperature in an inert atmosphere; (d) washing the cooled material of step (c) with water to remove BaCl.sub.2; and (e) drying the washed material of step (d) to remove the water and to produce the free flowing powder consisting essentially of spheroidal particulate BaFCl:Eu phosphor.” However the patent does not disclose BaFCl:Eu phosphor compositions that have been filtered in order to have particles sizes larger than 10 μm.

Commercially available scintillator screens are typically optimized for transmission X-ray medical and non-destructive test (NDT) imaging applications and are characterized by both the ability to stop as many X-rays as possible in the phosphor layer and to maintain a high spatial resolution across the screen by limiting the spreading of light in the screen. These two requirements are achieved by (1) utilizing a high atomic number scintillator which is densely packed within the screen and (2) limiting light spreading in the scintillator layer. In order to obtain phosphor-based scintillator screens optimized for transmission X-ray medical and NDT imaging applications, phosphor powders are manufactured with a mean grain size distribution ranging from approximately 2 μm to 15 μm. The resulting particle size distribution (PSD) of phosphor limits light spreading in the scintillator layer and also allows the phosphor particles/grains to be densely packed when deposited over a supporting substrate layer.

In X-ray detector panels that use densely packed phosphor-based scintillator screens, light generated in one region of the panel is unable to travel across distances greater than about 100 μm, due to the large amount of light scattering and absorption in the scintillator by small, i.e. less than 10 μm, phosphor particles. As a result, X-ray images generated by such detectors have spatial resolutions ranging from approximately 30 μm to 200 μm (depending on the exact composition of the scintillator screen and the size of the photo sensor employed), which is the required resolution for obtaining good quality medical and NDT images.

In contrast with medical and NDT applications, certain backscatter and transmission X-ray imaging applications do not require limited light spread in the scintillation layer or preservation of spatial resolution for sizes below 200 μm. For example, backscatter X-ray detection performance improves with increased transparency in the scintillation layer, leading to better light extraction and more light photons exiting the screen. Current backscatter imaging performance is limited by the maximum stopping power of the scintillation screen. As the areal density of the phosphor layer in the screen increases, the number of X-rays which are absorbed increases, which in turn, improves the imaging performance. However, due to strong light absorption within the phosphor layer, the number of light photons which exit the phosphor layer diminishes as the phosphor layer areal density increases. For a film having a mass of phosphor per area greater than about 150 mg/cm², additional scintillator material decreases the imaging performance because a significant fraction of scintillation light does not exit the screen. Hence, scintillator screens in known X-ray backscatter detectors typically have a mass of phosphor per area ranging from 80 mg/cm² to 150 mg/cm² and have an absorption that results in approximately 25-30% of the total X-rays incident on the detector being lost for a typical source energy of 220 kV. With increasing source energy, the fraction of lost X-rays increases with higher source energy.

Thus, there is need for an improved scintillator screen that has higher transparency thereby allowing thicker scintillator layers and resulting in higher quality X-ray backscatter images. In addition, for improving backscatter imaging quality there is need to provide scintillator screens that avoid characteristics which increase light absorption or scatter.

In addition to improved image quality, a phosphor with increased transparency has higher scintillation light output per X-ray absorbed in the scintillator. Increased light output is advantageous for reducing the photodetector area, leading to a reduced cost of the X-ray detector. Backscatter X-ray detectors require a fixed fraction of photodetector area to total X-ray detector surface area. The fraction is directly related to the light output of the scintillator (number of light photons output per X-ray input to the scintillator layer). Improving the transparency of the scintillator increases the light output and reduces the fraction of photodetector area required in direct proportion.

Finally, an increase in the light output of the scintillator enables more compact detector designs. For compact X-ray systems, it is advantageous for the X-ray detector to occupy a minimum volume of the system enclosure. Thickness of backscatter X-ray detectors is currently limited by the light output of the scintillator. Scintillation light is absorbed during transport of the light to the photodetector when the light reflects from the walls. A thin detector increases the number of reflections from the detector walls prior to hitting the photodetector. Increasing the light output from the scintillator compensates for the light lost with increased reflections from a thin detector.

X-rays can be absorbed at any depth within a scintillation screen. An X-ray photon absorbed near an exit surface of the screen coupled with a photodetector, suffers virtually no loss of energy/light while exiting the screen. However, another X-ray photon with the same energy absorbed at an opposing end of the screen (further away from the exit surface of the screen coupled with a photodetector) suffers a maximum loss of energy/light while exiting the screen (undergoes a maximum amount of light absorption). The variation of light output as a function of absorption depth in the scintillator screen creates an additional noise, also known as Swank noise or optical photon collection noise, degrades the image quality.

As such, there is need for a scintillator screen having an increased or high transparency, wherein the light output variance with depth is decreased, thereby limiting generation of Swank noise. There is also a need for scintillator screens that are optimized for X-ray imaging having improved light extraction features and that do not increase light absorption or scatter, even at the cost of thicker screens and increased light spreading.

### SUMMARY

The following embodiments and aspects thereof are described and illustrated in conjunction with systems, tools and methods, which are meant to be exemplary and illustrative, and not limiting in scope. The present application discloses numerous embodiments.

The present specification discloses an X-ray detector comprising: a housing; at least one photosensor coupled to the housing; and a scintillator screen coupled to the housing and in light communication with the at least one photosensor, wherein the scintillator screen comprises a scintillator layer having a plurality of phosphor particles and wherein a mean particle size of the plurality of phosphor particles is in a range of 30 μm to 70 μm.

Optionally, the X-ray detector is a backscatter detector. Optionally, a thickness of the scintillator layer is in a range of 100 μm to 4000 μm. Optionally, the plurality of phosphor particles is made of europium-doped barium fluorochloride (BaFCl:Eu). Optionally, the plurality of phosphor particles is made of Gadolinium Oxysulfide (Gd₂O₂S).

Optionally, a packing fraction of a weight of the plurality of phosphor particles to a weight of a binder together with the plurality of phosphor particles is in a range of 50% to 90%.

Optionally, the scintillator screen further comprises an anti-scratch layer coupled to the scintillator layer. Optionally, the scintillator screen further comprises a reflector layer coupled to the scintillator layer such that the scintillator layer is sandwiched between the reflector layer and the anti-scratch layer. Optionally, the scintillator screen further comprises a release liner coupled to the reflector layer.

Optionally, a smallest of the plurality of phosphor particles has a particle size that is within 20% of a particle size of a largest of the plurality of phosphor particles.

Optionally, a transparency of the scintillator screen is in a range of 10% greater than a transparency of a second scintillator screen, wherein the second scintillator screen comprises phosphor particles having particle sizes below 30 um.

Optionally, wherein the X-ray detector is a transmission detector. Optionally, a thickness of the scintillator layer is in a range of 100 μm to 4000 μm. Optionally, the plurality of phosphor particles is made of europium-doped barium fluorochloride (BaFCl:Eu). Optionally, a pixel pitch is larger than 350 μm. Optionally, the plurality of phosphor particles is made of Gadolinium Oxysulfide (Gd₂O₂S). Optionally, a pixel pitch is larger than 200 μm.

Optionally, a packing fraction of a weight of the plurality of phosphor particles to a weight of a binder together with the plurality of phosphor particles is in a range of 50% to 90%.

Optionally, the scintillator screen further comprises an anti-scratch layer coupled to the scintillator layer. Optionally, the scintillator screen further comprises a reflector layer coupled to the scintillator layer such that the scintillator layer is sandwiched between the reflector layer and the anti-scratch layer. Optionally, the scintillator screen further comprises a release liner coupled to the reflector layer.

Optionally, a smallest of the plurality of phosphor particles has a particle size that is within 20% of a particle size of a largest of the plurality of phosphor particles.

Optionally, a transparency of the scintillator screen is in a range of 10% greater than a transparency of a second scintillator screen, wherein the second scintillator screen comprises phosphor particles having particle sizes below 30 um.

The present specification also discloses a scintillator screen for use in a backscatter x-ray detector, the scintillator screen comprising at least a phosphor layer comprising a plurality of phosphor particles wherein a mean particle size of the plurality of phosphor particles is in a range of 30 μm to 70 μm.

Optionally, the phosphor layer comprises europium-doped barium fluorochloride (BaFCl:Eu).

Optionally, a thickness of the scintillator layer ranges from 100 μm 4000 μm.

Optionally, a packing fraction of phosphor weight to total weight of phosphor and a binder ranges from 50% to 90%.

Optionally, a X-ray stopping power is a ratio of the number of x-ray photons absorbed in the scintillator versus the total number of input X-ray photons.

Optionally, a transparency is an amount of light which passes out of the screen normalized to a total amount of light generated in the scintillator screen.

Optionally, a light output per captured X-ray is the ratio of a total number of scintillation light photons exiting the film for each x-ray photon stopped in the film.

Optionally, the phosphor layer comprises a uniform distribution of equal-sized phosphor particles.

Optionally, plate-like phosphor particles are milled.

Optionally, phosphor particles not within a predefined size range are removed via mechanical sieving.

Optionally, the predefined mean particle size range is from 30 μm to 70 μm, and preferably from 30 μm to 50 μm.

The present specification also discloses a backscatter X-ray detector comprising a scintillator screen comprising at least a phosphor layer comprising a plurality of phosphor particles wherein each of the plurality phosphor particles has a particle size in a range of 30 μm to 70 μm, and preferably from 30 μm to 50 μm.

Optionally, the phosphor layer comprises europium-doped barium fluorochloride (BaFCl:Eu).

The aforementioned and other embodiments of the present specification shall be described in greater depth in the drawings and detailed description provided below.

### BRIEF DESCRIPTION OF THE DRAWINGS

The accompanying drawings illustrate various embodiments of systems, methods, and embodiments of various other aspects of the disclosure. Any person with ordinary skill in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1A is a block diagram representing an X-ray detector comprising a scintillator screen in accordance with embodiments of the present specification;

FIG. 1B is a diagrammatical representation of the constituent layers of the scintillator screen shown in FIG. 1A;

FIG. 2A is a graph illustrating the relationship between scintillator areal density and light output per captured photon in a scintillator screen, in accordance with embodiments of the present specification;

FIG. 2B is a graph illustrating the relationship between an areal density of a scintillator screen and a backscatter detector signal-to-noise ratio, in accordance with an embodiment of the present specification;

FIG. 3 is a block diagram representing an X-ray detector for use in transmission imaging systems, in accordance with some embodiments of the present specification; and

FIG. 4 is a graph illustrating the relationship between an areal density of a scintillator screen and the signal to noise ratio of photodetector pixel, in accordance with some embodiments of the present specification.

### DETAILED DESCRIPTION

The present specification provides a scintillator screen that is optimized for use in X-ray backscatter detectors for maximizing performance of the detector in backscatter X-ray imaging applications. Embodiments of the present specification provide a backscatter imaging detector having use in non-medical applications, wherein the detector comprises a scintillator that has a high transparency. In various embodiments, the present specification provides scintillator layers composed of europium-doped barium fluorochloride (BaFCl:Eu), wherein the mean particle size of the phosphor material has a predefined size, clarity, and packing fraction within the scintillator screen. In preferred embodiments, a mean particle size of the plurality of phosphor grains/particles ranges from 30 μm to 70 μm, and preferably 30 μm to 50 μm. In some embodiments, a particle size of each of the plurality of phosphor grains/particles ranges from 30 μm to 70 μm, and preferably 30 μm to 50 μm. In some embodiments, a smallest particle of the plurality of phosphor particles has a particle size that is within 50%, 40%, 30%, 20%, 15%, 10% and 5% and every numerical increment therein of a particle size of a largest of the plurality of phosphor particles.

In some embodiments, a transparency of the scintillator screen, optimized for use in X-ray backscatter detectors, is in a range of 10% greater than a transparency of a scintillator screen comprising phosphor particles having particle sizes below 30 μm. In some embodiments, the transparency of the scintillator screen, optimized for use in X-ray backscatter detectors, increases by 50%, 40%, 30%, 20%, 15%, 10% and 5% and every numerical increment therein of a scintillator screen having phosphor particle sizes below 30 μm.

The present specification further provides a scintillator screen that is optimized for use in X-ray transmission detectors for maximizing performance of the detector in transmission X-ray imaging applications. In embodiments, the present specification describes a transmission imaging detector having use in non-medical applications, wherein the detector comprises a scintillator layer that has a phosphor grain size and an areal thickness or density that is higher than conventional screens. In preferred embodiments, the present specification provides a scintillator layer composed of gadolinium oxysulfide (Gadox), wherein the mean particle size of the plurality of phosphor grains/particles ranges from 30 μm to 70 μm, and preferably 30 μm to 50 μm. In some embodiments, a particle size of each of the plurality of phosphor grains/particles ranges from 30 μm to 70 μm, and preferably 30 μm to 50 μm. In some embodiments, a smallest of the plurality of phosphor particles has a particle size that is within 50%, 40%, 30%, 20%, 15%, 10% and 5% and every numerical increment therein of a particle size of a largest of the plurality of phosphor particles.

In some embodiments, a transparency of the scintillator screen, optimized for use in X-ray transmission detectors, is in a range of 10% greater than a transparency of a scintillator screen comprising phosphor particles having particle sizes below 30 μm. In some embodiments, the transparency of the scintillator screen, optimized for use in X-ray transmission detectors, increases by 50%, 40%, 30%, 20%, 15%, 10% and 5% and every numerical increment therein of a scintillator screen having phosphor particle sizes below 30 μm.

For both backscatter and transmission imaging detectors, it is preferred that the mean particle size of the plurality of phosphor grains/particles ranges from 30 μm to 70 μm, and preferably 30 μm to 50 μm. It should be appreciated that the phosphor production process produces a range of particle sizes from small, for a few particles, to large. However, the overall detector performance and scintillator film transparency trend follows the mean particle size.

Thus, in embodiments, phosphor-based scintillator screens having improved light transmission may be beneficial for the following applications: backscatter X-ray detectors, transmission X-ray detectors with an areal density larger than conventional screens, and phosphor-based neutron detectors. Examples of phosphor-based scintillator materials which may be useful include BaFCl:Eu, Gd₂O₂S:Pr, Ce, F or Tb doped, ⁶LiF ZnS:Ag, ⁶LiF ZnO:Zn. Other similar phosphor materials are possible and may also benefit from the improved light transmission.

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

In the description and claims of the application, each of the words “comprise”, “include”, “have”, “contain”, and forms thereof, are not necessarily limited to members in a list with which the words may be associated. Thus, they are intended to be equivalent in meaning and be open-ended in that an item or items following any one of these words is not meant to be an exhaustive listing of such item or items, or meant to be limited to only the listed item or items. It should be noted herein that any feature or component described in association with a specific embodiment may be used and implemented with any other embodiment unless clearly indicated otherwise.

It should also be noted that as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred, systems and methods are now described.

As used throughout this specification, the term “film areal density” is used to refer to a physical parameter of mass per area of the scintillator film which includes both the scintillator particles and the plastic binder. The overall density of the scintillator layer is determined by the ratio of the two materials (the scintillator particles and the plastic binder).

As used throughout this specification, the term “X-ray stopping power” refers to the fraction of X-rays absorbed in the scintillator screen normalized to the total X-rays incident upon the screen or, more simply stated, the number of X-ray photons absorbed in the scintillator versus the total number of input X-ray photons. The stopping power is dependent on many factors including the total areal density of the film, the ratio of binder to scintillator, the density and atomic number of the material used in the scintillator particles and the energy of the x-ray photon.

As used throughout this specification, for each X-ray absorbed, the light output is defined at the fraction of scintillation light photons exiting the screen normalized to the total number of light photons generated per X-ray photon, thereby defining the light output per X-ray photon absorbed. In other words, the light output per captured X-ray is the total number of scintillation light photons exiting the film for each X-ray photon stopped in the film.

### Backscatter X-Ray Detector

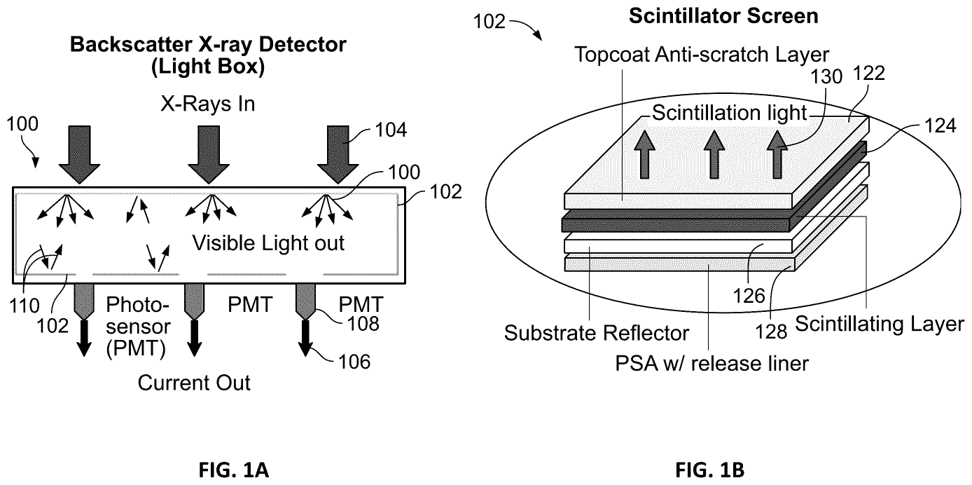

FIG. 1A is a block diagram representing an X-ray detector comprising a scintillator screen. Backscatter X-ray detector 100 also referred to as a light box comprises a scintillator screen 102 that absorbs incoming X-ray radiation 104. The material of the scintillator 102 is excited to luminescence by the absorbed radiation, resulting in emission of visible or near-visible light photons, which in turn, are converted to electrical pulses 106 by a plurality of photo multiplier tubes (PMT) 108 coupled with the light box 100. As shown in FIG. 1A, some of the X-ray radiation 110 impinging upon detector 100 is completely absorbed by the scintillator screen 102 with no emission of corresponding visible light photons.

FIG. 1B is a diagrammatical representation of the constituent layers of the scintillator screen shown in FIG. 1A. Referring to FIGS. 1A and 1B, scintillator screen 102 comprises a top anti-scratch layer 122, followed by a scintillator layer 124, a reflector layer made of a substrate material 126 and a PSA (photo sensor array) layer 128 with release liner. As shown, scintillator screen 120 emits scintillation light 130 comprising visible light photons corresponding to absorbed X-ray radiation 104. In various embodiments of the present specification the scintillator layer 124 is made of phosphor captured in a polymeric binder material. In an embodiment, the scintillator layer 124 comprises europium-doped barium fluorochloride (BaFCl:Eu), wherein the emission of scintillation light 130 occurs in the violet and ultraviolet region of the spectrum. This feature makes the use of BaFCl:Eu as a luminescent material in backscatter X-ray detectors a better choice than other scintillator materials such as, but not limited to, Calcium Tungstate. As described in U.S. Pat. No. 9,285,488, assigned to the Application of the present specification and herein incorporated by reference in its entirety, the preferred scintillator material is europium-doped barium fluorochloride (BaFCl:Eu), although other scintillators, such as BaFI:Eu, or other lanthanide-doped barium mixed halides (including, by way of further example, BaBrI:Eu and BaCsI:Eu), may be used within the scope of the present invention. Additionally, the same improvements may also be realized in gadolinium oxysulfide (Gd₂O₂S, or “Gadox”) doped with rare earth elements.

Backscatter X-ray detection performance improves with increased transparency in the scintillation layer 124, leading to better light extraction and a higher number of visible light photons 130 exiting the screen 120, wherein “transparency” (or also referred to as “clarity”) of the scintillator screen may be described as the amount of light which passes through and out of the screen medium normalized to the total amount of light generated in the scintillator screen. This typically includes both scintillation light scatter and absorption as loss mechanisms. In various embodiments, the present specification provides a method of making scintillator screens composed of europium-doped barium fluorochloride (BaFCl:Eu), wherein each grain of the phosphor material has a predefined size and packing fraction within the scintillator layer.

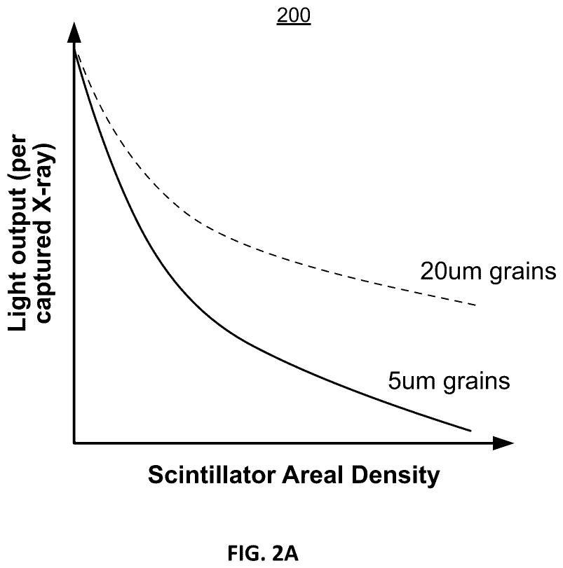

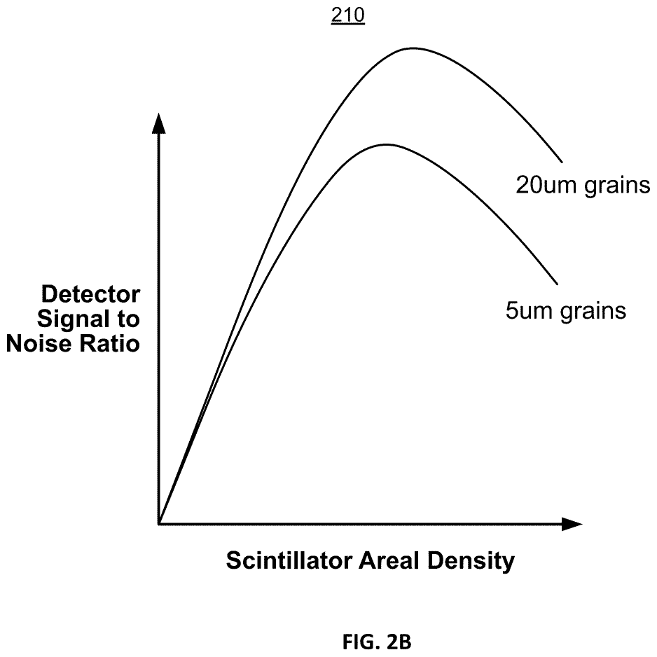

FIG. 2A is a graph 200 illustrating the relationship between scintillator areal density and light output per captured photon in a scintillator screen, in accordance with embodiments of the present specification. The X-ray stopping power of the screen increases with additional areal density of scintillator material. As can be seen in FIG. 2A, as the X-ray stopping power increases (with an increase in the areal density of scintillator material), the light output per captured photon decreases both for 20 μm mean particle size and 5 μm mean particle size phosphor grains in the scintillator layer. However, with increase in X-ray stopping power (due to increase in the areal density of scintillator material) of the scintillator screen, the light output of the 20 μm mean particle sized scintillation layer is higher than that of the 5 μm mean particle sized scintillation layer. In various embodiments, the larger grain size of phosphor particles in the scintillator screen leads to a reduction in light scattered or absorbed by the screen and thus, an increase in the mean path length of the scintillation light. Further, the larger grain size phosphor particles in the scintillator screen leads to fewer interfaces between the phosphor particles and binder in the screen thereby reducing self-absorption of light in the scintillator layer.

FIG. 2B is a graph 210 illustrating the relationship between an areal density of a scintillator screen and a backscatter detector signal-to-noise ratio (SNR), in accordance with an embodiment of the present specification. As shown larger sized phosphor grains (20 μm) leading to a thicker scintillator screen leads to better SNR than smaller sized phosphor grains (5 μm) in a thinner scintillator screen.

In embodiments, an optimum scintillator screen transparency is obtained by processing BaFCl:Eu in a manner that results in a larger grain size than available in prior art. In embodiments, the process of obtaining BaFCl:Eu for producing scintillator screens comprises filtration of optionally milled BaFCl:Eu particles in order to obtain phosphor particles of a predefined mean size (since Europium Oxide is one component of the melt, it is incorporated in the BaFCl in the initial firing.). In an embodiment, mechanical sieving is used to filter particles of undesired size, wherein the sieving is achieved by placing the milled BaFCl:Eu particles on a mechanical screen with a mesh size equal to the smallest grain size preferred in the scintillator screen. Consequently, BaFCl:Eu grains that are smaller than the mesh size are removed from the finished product.

In an embodiment, BaFCl:Eu is synthesized without spray drying and is kept pristine (unfiltered) to preferably obtain a plurality of particles having a mean particle size ranging from 30 μm to 70 μm, and preferably 30 μm to 50 μm. In another embodiment, each of the plurality of particles has a particle size in a range of 30 μm to 70 μm, and preferably 30 μm to 50 μm. In some embodiments, a smallest particle of the plurality of particles has a particle size that is within 50%, 40%, 30%, 20%, 15%, 10% and 5% and every numerical increment therein of a particle size of a largest of the plurality of particles.

The use of such large grain sizes of phosphor material provides scintillator screens characterized by a two-fold increase in the mean propagation path length of scintillator light compared to conventional methods. Additionally, the use of such large grain sizes of phosphor material provides scintillator screens having a transparency level that is more than that available in the prior art, wherein such scintillator screens are better suited for X-ray backscatter detector application. In some embodiments, a transparency of the scintillator screen of the present specification is in a range of 10% greater than a transparency of a prior art scintillator screen comprising phosphor particles having particle sizes below 30 μm. In some embodiments, the transparency of the scintillator screen of the present specification increases by 50%, 40%, 30%, 20%, 15%, 10% and 5% and every numerical increment therein of a prior art scintillator screen having phosphor particle sizes below 30 μm.

In embodiments, plate-like phosphor particles are optionally milled, which may result in a distribution of grain size with some smaller, undesirable grains present. Subsequently, the phosphor particles are classified and filtered/sieved after synthesis and optional milling to obtain particles that are less plate-like and that are within a preferred predefined mean particle size range, which is 30 μm to 70 μm, and preferably 30 μm to 50 μm. In some embodiments, each of the obtained particles has a particle size in a range of 30 μm to 70 μm, and preferably 30 μm to 50 μm.

Although it is desirable to maximize the phosphor content in a scintillator screen, generally, phosphor particles having a plate-like habit require a higher binder to phosphor ratio than those that are more spheroidal. Furthermore, screens made with plate-like phosphor particles are more prone to bubble or blister when the protective layers are applied, and this results in an unacceptable screen. Conventionally, the plate-like phosphor particles are milled and classified in order to obtain particles that are less plate-like and that are within a desired size range.

In embodiments, the present specification provides an optimum value for a total density of deposited phosphor layer on a support substrate in order to obtain a scintillator screen optimized for X-ray backscatter detector application. In embodiments, the overall packing fraction of phosphor (and binder) in a scintillator screen optimized for backscatter imaging is reduced as compared to prior art screens in order to ensure that no additional voids are created by the large grains of phosphor. The present specification, in embodiments, provides an optimal range of the ratio of the packing fraction of phosphor weight to total weight (including phosphor and binder) in the screen. In an embodiment, the optimal range is approximately 70%-90% packing fraction of phosphor weight to total weight (including phosphor and binder).

Hence, in various embodiments, the present specification provides a phosphor based scintillator screen composed of europium-doped barium fluorochloride (BaFCl:Eu) optimized for backscatter imaging, wherein the screen comprises phosphor grains having a predefined mean size which is larger than the grain size of phosphor in prior art scintillator screens used for applications such as, but not limited to, medical, security and NDT imaging. Further, the scintillator screen of the present specification comprises phosphor grains of a uniform size with no smaller grains present, wherein the uniform distribution of larger grains of phosphor is obtained by the process of sieving. Larger phosphor grains in the scintillator screens provide better image quality because of reduced light scattering, decreased self-absorption of light within the screen and improved light extraction from impinging X-ray radiation on the screen. Yet further, the present specification provides a scintillator screen having a mean particle size of phosphor grains not exceeding 70 μm in order to prevent non-uniform large agglomerations in the scintillator layer. In some embodiments, a thickness of the scintillator layer ranges from 100 μm 4000 μm.

### Transmission X-Ray Detector

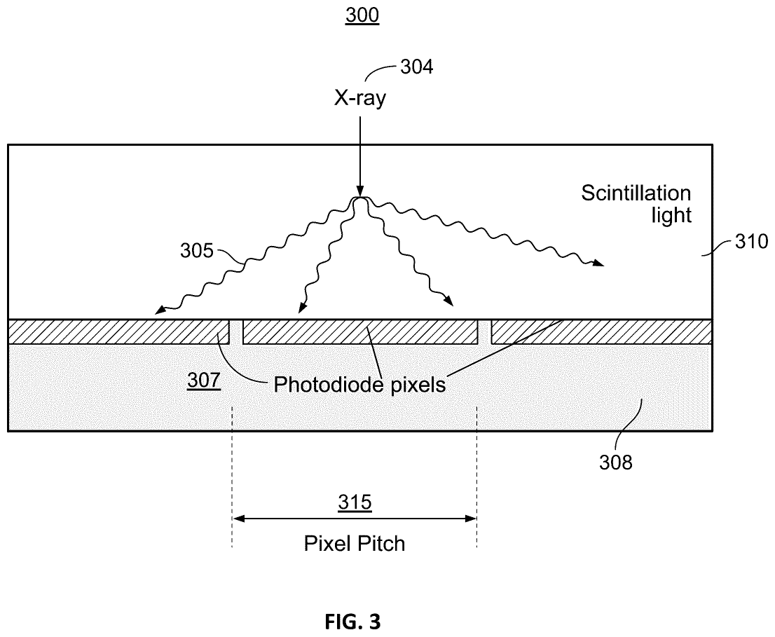

FIG. 3 is a block diagram representing an X-ray detector 300 for use in transmission imaging systems, in accordance with some embodiments of the present specification. The transmission X-ray detector 300 is a pixelated indirect (that is, scintillating or a detection process that first requires the intermediate step of converting X-rays to light) detector comprising a scintillator 310 that absorbs incoming X-ray radiation 304. The material of the scintillator 310 is excited to the point of luminescence by the absorbed radiation, resulting in emission of visible or near-visible light photons 305 (also referred to as ‘scintillation light’), which, in turn, are converted to electrical pulses by a plurality of photodetectors or photodiode pixels 308 coupled with the X-ray detector 300.

The transmission X-ray detector 300 comprises pixels 307 in a one-dimensional (i.e. a single column or row) or two-dimensional array (i.e. more than one column and row). In some embodiments, the detector pixels are square or rectangular in shape such that a smallest lateral dimension of a pixel, which has neighboring pixels, is larger in size (approximately 1.5 to 2 times) than an areal density of the scintillator 310. This reduces the amount of cross-talk between the detector pixels. Stated differently, in some embodiments, an areal density of the scintillator 310 is no more than 1.5 to 2 times a pixel pitch 315 or a width of the active area of a pixel (assuming the dead region is small). In some embodiments, a mass per area (that is, the areal density) of the scintillator layer 310 is 150 mg/cm² or higher and the pixel pitch 315 is larger than 200 μm (for Gadox scintillator layer) and 350 μm (for BaFCl scintillator layer). In some embodiments, a thickness of the scintillator layer ranges from 100 μm 4000 μm.

In various embodiments, transmission imaging systems employ a pencil, fan or cone beam X-ray source. In a non-limiting example of a transmission imaging system for baggage scanning, the imaging system typically includes a fan beam collimated X-ray source and a linear array of scintillator and photodiode detector pixels. In some embodiments, the pixel size is approximately 1 mm in dimension. A linear array typically contains at least one column. Linear arrays are produced in sections ranging from 30 to 100 pixels depending on the overall detector size. The detector modules are placed in a line with individual modules oriented perpendicular to the focal spot. Two-dimensional arrays typically range from 30 μm to 200 μm in size, while linear arrays can range from 500 μm to 5000 μm in size.

In some embodiments, the scintillator comprises a gadolinium oxysulfide (Gd₂O₂S, or “Gadox”) phosphor sheet applied to a photodetector (for example, a silicon photodiode). In some embodiments, the scintillator comprises Gadox phosphor powder in a binder coated onto the photodetector. It should be appreciated that Gadox has an emission peak at 525 nm which is a better spectral match to the response of silicon photodiodes typically used as photodetectors in X-ray transmission systems. X-ray backscatter systems typically use photomultiplier tubes as photodetectors, which have much higher spectral response in the UV/blue range, and thus are well suited to BaFCl as the scintillator. It should be noted herein that while the use of BaFCl as a scintillator for a transmission detector is not precluded, it is not preferred due to the use of silicon or amorphous silicon as the photodetector in pixelated detectors (not photomultipliers as in backscatter systems). The sensitivity of silicon at 390 nm (the emission wavelength of BaFCl) is approximately 60%. In contrast, the sensitivity of silicon at 545 nm (the emission wavelength of Gadox) is close to 100%.

Persons of ordinary skill in the art would appreciate that, in a conventional scintillator, the emitted visible light photons 305 scatter in all directions thereby degrading spatial resolution. In embodiments of the present specification, the use of a larger grain size of phosphor particles in the scintillator screen, for a transmission detector (such as, the transmission detector 300), lead to a reduction of light scattered in the screen. Also, the larger grain size phosphor particles in the scintillator screen enhance the transparency of the screen. Consequently, in various embodiments, the present specification provides a phosphor-based scintillator screen composed of Gadox optimized for transmission imaging, wherein the screen comprises phosphor grains having a predefined size which is larger than the grain size of phosphor in conventional scintillator screens. In some embodiments, a preferred predefined mean particle size of a plurality of phosphor grains ranges from 30 μm to 70 μm, and preferably 30 μm to 50 μm for use in transmission detectors. In some embodiments, a predefined particle size of each of a plurality of phosphor grains ranges from 30 μm to 70 μm, and preferably 30 μm to 50 μm for use in transmission detectors. In some embodiments, a smallest of the plurality of phosphor particles has a particle size that is within 50%, 40%, 30%, 20%, 15%, 10% and 5% and every numerical increment therein of a particle size of a largest of the plurality of phosphor particles. The use of such large grain sizes of phosphor material provides scintillator screens characterized by a two-fold increase in the mean path length of scintillator light as compared to prior methods.

In some embodiments, a transparency of the scintillator screen, for use in transmission detectors, is in a range of 10% greater than a transparency of a prior art scintillator screen comprising phosphor particles having particle sizes below 30 μm. In some embodiments, the transparency of the scintillator screen, for use in transmission detectors, increases by 50%, 40%, 30%, 20%, 15%, 10% and 5% and every numerical increment therein of a prior art scintillator screen having phosphor particle sizes below 30 μm.

For phosphor-based transmission detectors, such as the transmission detector 300, the total amount of X-rays that can be stopped is limited by the mean propagation length for scintillation light. Consequently, a scintillator which is thicker than the mean propagation length for light will yield light which does not strike the photodetector.

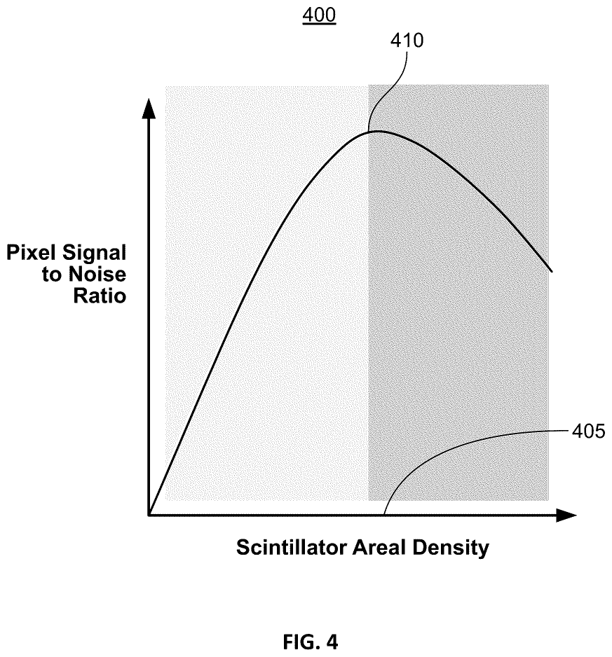

FIG. 4 is a graph 400 illustrating the relationship between an areal density of a scintillator screen and a signal to noise ratio (SNR) of photodetector pixel, in accordance with some embodiments of the present specification. As the areal density of the phosphor layer in the screen increases, from zero to a first areal density 405, the number of X-rays which are absorbed increases, which in turn, improves the transmission imaging performance to reach a maximum SNR 410 corresponding to the first areal density 405. However, due to strong light absorption within the phosphor layer, the number of light photons which exit the phosphor layer diminishes as the areal density of the phosphor layer increases above the first areal density 405. Consequently, the SNR degrades as the areal density of the phosphor layer increases above the first areal density 410. The peak SNR 410 is typically at a mass of phosphor per area (that is, an areal density) of 150 mg/cm².

Accordingly, in embodiments, the present specification provides an optimum areal density of the scintillator 310 that maximizes the SNR for large grain phosphors. In various embodiments, for large grain phosphors the optimal areal density of the phosphor coating ranges from 100 mg/cm² to 600 mg/cm². In some embodiments, the optimal thickness of the scintillator ranges from 0.5 mm to 2.5 mm, and is preferably about 1 mm.

The scintillator layer may be deposited, from a liquid state, directly onto a photodetector with no supporting substrate or may be deposited onto a substrate to form a screen which can be installed into an enclosure.

Thus, in various embodiments, the present specification provides a phosphor-based scintillator screen composed of Gadox optimized for transmission imaging, wherein the screen comprises phosphor grains having a predefined size which is larger than the grain size of phosphor in prior art scintillator screens. In various embodiments, the present specification further provides a phosphor-based scintillator screen composed of Gadox optimized for transmission imaging, wherein the screen has a higher areal density (facilitated by larger phosphor grains) compared to prior art scintillator screens.

The above examples are merely illustrative of the many applications of the system of present specification. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

What is claimed is:

1. An X-ray detector comprising
a housing;
at least one photosensor coupled to the housing; and
a scintillator screen coupled to the housing and in light communication with the at least one photosensor, wherein the scintillator screen comprises a scintillator layer having a plurality of phosphor particles and wherein a mean particle size of the plurality of phosphor particles is in a range of 30 μm to 70 μm.

2. The X-ray detector of claim 1, wherein the X-ray detector is a backscatter detector.

3. The X-ray detector of claim 2, wherein a thickness of the scintillator layer is in a range of 100 μm to 4000 μm.

4. The X-ray detector of claim 3, wherein the plurality of phosphor particles is made of europium-doped barium fluorochloride (BaFCl:Eu).

5. The X-ray detector of claim 3, wherein the plurality of phosphor particles is made of Gadolinium Oxysulfide (Gd₂O₂S).

6. The X-ray detector of claim 2, wherein a packing fraction of a weight of the plurality of phosphor particles to a weight of a binder together with the plurality of phosphor particles is in a range of 50% to 90%.

7. The X-ray detector of claim 2, wherein the scintillator screen further comprises an anti-scratch layer coupled to the scintillator layer.

8. The X-ray detector of claim 7, wherein the scintillator screen further comprises a reflector layer coupled to the scintillator layer such that the scintillator layer is sandwiched between the reflector layer and the anti-scratch layer.

9. The X-ray detector of claim 8, wherein the scintillator screen further comprises a release liner coupled to the reflector layer.

10. The X-ray detector of claim 2, wherein a smallest of the plurality of phosphor particles has a particle size that is within 20% of a particle size of a largest of the plurality of phosphor particles.

11. The X-ray detector of claim 2, wherein a transparency of the scintillator screen is in a range of 10% greater than a transparency of a second scintillator screen, wherein the second scintillator screen comprises phosphor particles having particle sizes below 30 um.

12. The X-ray detector of claim 1, wherein the X-ray detector is a transmission detector.

13. The X-ray detector of claim 12, wherein a thickness of the scintillator layer is in a range of 100 μm to 4000 μm.

14. The X-ray detector of claim 13, wherein the plurality of phosphor particles is made of europium-doped barium fluorochloride (BaFCl:Eu).

15. The X-ray detector of claim 14, wherein a pixel pitch is larger than 350 μm.

16. The X-ray detector of claim 13, wherein the plurality of phosphor particles is made of Gadolinium Oxysulfide (Gd₂O₂S).

17. The X-ray detector of claim 16, wherein a pixel pitch is larger than 200 μm.

18. The X-ray detector of claim 12, wherein a packing fraction of a weight of the plurality of phosphor particles to a weight of a binder together with the plurality of phosphor particles is in a range of 50% to 90%.

19. The X-ray detector of claim 12, wherein the scintillator screen further comprises an anti-scratch layer coupled to the scintillator layer.

20. The X-ray detector of claim 19, wherein the scintillator screen further comprises a reflector layer coupled to the scintillator layer such that the scintillator layer is sandwiched between the reflector layer and the anti-scratch layer.

21. The X-ray detector of claim 20, wherein the scintillator screen further comprises a release liner coupled to the reflector layer.

22. The X-ray detector of claim 12, wherein a smallest of the plurality of phosphor particles has a particle size that is within 20% of a particle size of a largest of the plurality of phosphor particles.

23. The X-ray detector of claim 12, wherein a transparency of the scintillator screen is in a range of 10% greater than a transparency of a second scintillator screen, wherein the second scintillator screen comprises phosphor particles having particle sizes below 30 um.
